(19) United States
(12) Patent Application Publication
(10) Pub. No.: US 2025/0094910 A1
(43) Pub. Date: Mar. 20, 2025

(54) SYSTEM AND METHOD TO DETERMINE AGENT PROFICIENCY FOR A SKILL

(71) Applicant: NICE LTD., Ra’anana (IL)

(72) Inventors: Swati KADU, Pune (IN); Salil DHAWAN, Pune (IN); Pramod GIRI, Pune (IN); Nachiket DESHPANDE, Pune (IN); Hitesh MADNANI, Pune (IN); Digambar KUMAR, Jamui (IN); Bhagyashree BHOYAR, Pune (IN)

(21) Appl. No.: 18/471,090

(22) Filed: Sep. 20, 2023

(51) Int. Cl. G06Q 10/0639

(52) U.S. Cl. CPC G06Q 10/06393

(57) ABSTRACT

Agent proficiency scoring systems and methods, and non-transitory computer readable media, include receiving performance details and behavior details for an agent; calculating a performance score and a behavior score for the agent based on the performance details and the behavior details; combining the performance score and the behavior score to yield a current proficiency score of the agent; calculating a proficiency deviation between the current proficiency score of the agent and a previous proficiency score of the agent; determining whether the proficiency deviation of the agent is within an acceptable range; automatically updating the previous proficiency score, or transmitting a proficiency score request to a supervisor of the agent for review; and implementing one or more actions based on the current proficiency score or the previous proficiency score of the agent.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems for determining agent proficiency, and more particularly to methods and systems that determine agent proficiency based on a combination of performance and behavior across skills.

### BACKGROUND

In today's contact centers, each agent is equipped to handle customer interactions concurrently on traditional, as well as digital channels. This substantially increases contact center performance by improving agent productivity and utilization. Agents can now serve several customers simultaneously.

With increased interactions, it is difficult for a supervisor to determine agent proficiency. It is significant, however, that agents' proficiency be evaluated periodically.

There is currently no solution believed to be available that determines agent proficiency based on a combination of performance and behavior across skills in multichannel contact centers. Thus, agents are not assigned to appropriate proficiency levels, which could impact customer interactions. When agent performance degrades, it can have a cascading impact on subsequent interactions. Therefore, this could cause decreased customer satisfaction.

Supervisors have limited bandwidth to evaluate and update agents' proficiency. For voice channels, they must generally listen to the live call and make a judgment on proficiency. For non-voice channels, they typically have to review the interactions and make a judgment on proficiency through non-standardized methods. Thus, supervisors decide and approve proficiency, and may overlook certain factors such as agent behavior or past escalation, which could lead to an incorrect proficiency being set.

Accordingly, what is needed is a system and method to determine agent proficiency that will bring more visibility into the performance of agents when they are working on multiple interactions concurrently.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of a system according to embodiments of the present disclosure.

FIG. 2 is a simplified block diagram that integrates an agent proficiency scoring system into performance management according to embodiments of the present disclosure.

FIG. 3 is a flowchart of a method according to embodiments of the present disclosure.

FIG. 4 is a flowchart of a method of updating proficiency score according to embodiments of the present disclosure.

FIG. 5 is an exemplary screenshot of a supervisor dashboard according to embodiments of the present disclosure.

FIG. 6 is an exemplary screenshot depicting how a supervisor can manually approve a proficiency score according to embodiments of the present disclosure.

FIG. 7 is an exemplary screenshot depicting how a supervisor can manually reject a proficiency score according to embodiments of the present disclosure.

FIG. 8 is a block diagram of a computer system suitable for implementing one or more components in FIG. 1 or FIG. 2 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The presently disclosed systems and methods determine and update agent proficiency periodically, for example, during non-business hours. In various embodiments, the agent proficiency score is calculated by considering performance and behavior of the agent. The agent proficiency score helps to set the current proficiency level of each agent. A higher agent proficiency score is an indication of a highly efficient agent that can handle customer communications irrespective of the tasks assigned.

Advantageously, more accurate proficiency is obtained based on an algorithm that can be configured per contact center metrics. The workload of the supervisor is reduced considerably as the system updates the proficiency of agents. There is standardization of proficiency evaluation across skills, leading to less deviation. The competition between same proficiency level agents and/or implicit bias based on race can also be avoided There is real-time monitoring of any decline in the performance of agents. The present systems and methods also assist in identifying proficient agents because the proficiencies are periodically evaluated and updated. Overall, the present systems and methods reduce supervisor workload to assign appropriate proficiency of an agent for a skill, which leads to better customer satisfaction and engagement.

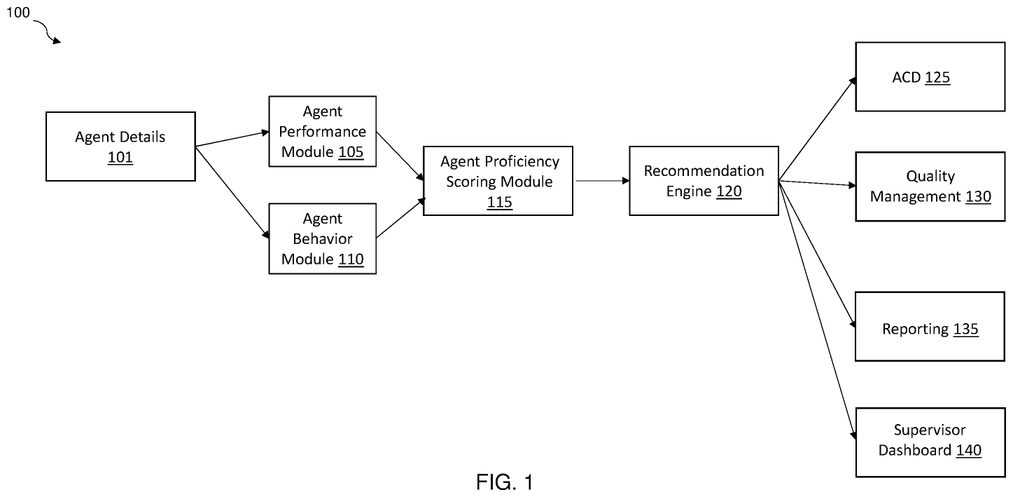

Referring now to FIG. 1, shown is a system 100 according to various aspects of the present disclosure. Agent details 101 are fed to agent performance module 105 and agent behavior module 110. Agent performance module 105 calculates the agent performance score based on past interactions while agent behavior module 110 calculates the agent behavior score based on past interactions. The past interactions may be the same or different when calculating agent performance and agent behavior scores, but preferably are the same. Agent proficiency scoring module 115 receives the agent performance score and the agent behavior score from agent performance module 105 and agent behavior module 110, calculates the agent proficiency score, and feeds the agent proficiency score to recommendation engine 120. Recommendation engine 120 transmits the agent proficiency score to one or more of automatic communication distributor (ACD) 125 to provide a better customer-agent match for a skill, to quality management 130 to recommend coaching if an agent needs improvement, to reporting 135 to provide a daily summary report of the agent proficiency score, and to supervisor dashboard 140 to take appropriate actions (such as assignment of automated actions) based on the agent proficiency score.

In some embodiments, ACD 125 connects the agent with the highest proficiency for a given skill or set of skills to a customer. These are typically skills expected to be required in the customer interaction, but alternatively may be overall skills of the agent. Typically, an ACD routes telephone calls, but any type of work item or communication can be given a digital signature and routed via the ACD. ACDs are specialized systems that are configured to match a work item to an available agent. ACDs generally receive incoming work items, determine where to route a particular work item, and connect the work item to an available employee. For the purposes of the present disclosure, “ACD” refers to any combination of hardware, software and/or embedded logic that is operable to automatically distribute incoming work items, including requests for service transmitted using any audio and/or video means, including signals, data or messages transmitted through voice devices, text chat, web sessions, facsimile, instant messaging and e-mail.

According to one or more embodiments, ACD 125 includes a processor, a network interface, and a memory module or database. The network interface joins ACD 125 with a local area network. Once ACD 125 receives a work item, the processor determines which of a plurality of agents should receive the work item. For example, the processor may access the memory module, which stores code executed by the processor to perform various tasks.

In various embodiments, the processor includes a plurality of engines or modules. Examples of suitable engines include a distributor engine, a queue engine, and a monitor engine. The distributor engine distributes incoming work items to available agents, the queue engine monitors and maintains work items that are waiting to be connected to agents, and the monitor engine checks the status and skills of agents and stores appropriate information in the memory module.

Supervisor dashboard 140 is a powerful tool to track and manage the performance of agents. It offers real-time insights into each agent's skill set, historical performance, and current status. With this dashboard 140, supervisors can efficiently evaluate and make data-driven decisions to enhance team productivity and overall efficiency. In various embodiments, a proficiency deviation is displayed on supervisor dashboard 140, the supervisor dashboard 140 provides key statistics regarding consistency in agent improvement, and/or automated agent realignment is based on the proficiency deviation.

In some embodiments, proficiency deviation is provided to quality management 130, which uses the proficiency deviation to assign coaching assignments. For example, depending on whether the proficiency deviation is greater than 80, between 50-80, or below 50, this can affect determination of which coaching assignments are assigned to best address the proficiency deviation, such as may be caused by the agent's need to improve one or more skills.

In one or more embodiments, proficiency deviation is calculated using the equation below.

$$Proficiency deviation = ( Agent Current Proficiency Score - Agent Previous Proficiency Score ) / Agent Previous Proficiency Score * 100$$

where Agent Current Proficiency Score is the agent proficiency score calculated by agent proficiency scoring module 115 and Agent Previous Proficiency Score is the past agent proficiency score that was stored in a database for future use (if the agent is new, then the supervisor provides input).

In one or more embodiments, if the proficiency deviation is positive and the deviation is less than a predetermined percentage, then the proficiency level is automatically increased. In some embodiments, if the proficiency deviation is negative and the deviation is less than a predetermined percentage, then the proficiency level is automatically decreased. The predetermined percentage is configurable. In an exemplary embodiment, the predetermined percentage is 50%.

In certain embodiments, the proficiency score is the sum of the agent performance score and the agent behavior score, providing a holistic representation of an agent's expertise.

In one or more embodiments, the agent performance score is the agent performance quotient multiplied by a weight. In various embodiments, the weight is 70%. In several embodiments, the agent behavior score is the agent behavior quotient multiplied by a weight. In one or more embodiments, the weight is 30%.

In several embodiments, the agent performance quotient is the sum of the agent quotient and the agent skill quotient for several agent parameters. The agent quotient measures how an agent is doing in the company or organization, and considers parameters such as agent duration in the company, rewards and recognition, agent absenteeism trend, agent occupancy rate, and average manager feedback issued over a selected past duration (e.g., a business day, 50 customer interactions, a workweek, etc.). The agent skill quotient measures how an agent is doing in interactions and considers parameters such as previous proficiency level, overall customer feedback, escalation count, schedule adherence, count of time-offs availed, and count of agent skills that agent performed over a specific interval.

In several embodiments, the agent behavior quotient is the sum of sentiment scores and considers parameters such as acknowledge loyalty, active listening, be empathetic, build rapport, demonstrate ownership, effective questioning, interruption, promote self-service, set expectations, speech velocity, and inappropriate action. Tables 1 and 2 below illustrate exemplary calculations of the agent performance quotient and the agent behavior quotient.

TABLE 1
AGENT PERFORMANCE QUOTIENT

| | Rating Determination | | | | Score |
|---|---|---|---|---|---|
| | Based on Parameter | Parameter | Rating | Weight | (rating × |
| Parameter | Value | Value | (0-5) | (1-5) | weight) |
| Agent duration | Less than 1 | 5 | 3 | 5 | 15 |
| in company | year/rating = 0 | years | | | |
| (Agent | 1 year or more and | | | | |
| Quotient | less than 3 years/ | | | | |
| Parameter) | rating = 1 | | | | |
| | 3 years or more | | | | |
| | and less than 5 years/ | | | | |
| | rating = 2 | | | | |
| | 5 years or more | | | | |
| | and less than 7 years/ | | | | |
| | rating = 3 | | | | |
| | 7 years or more | | | | |
| | and less than 10 | | | | |
| | years/rating = 4 | | | | |
| | 10 years or | | | | |
| | more/rating = 5 | | | | |
| Rewards and | More than 10 | 2 | 1 | 5 | 5 |
| recognition | rewards/rating = 5 | awards | | | |
| (Agent | More than 7 | | | | |
| Quotient | rewards/rating = 4 | | | | |
| Parameter) | More than 5 | | | | |
| | rewards/rating = 3 | | | | |
| | More than 3 | | | | |
| | rewards/rating = 2 | | | | |
| | 3 or less | | | | |
| | rewards/rating = 1 | | | | |
| | No rewards/rating = | | | | |
| | 0 | | | | |
| Agent | Zero absenteeism | 2 | 3 | 5 | 15 |
| absenteeism | to less than 5 schedules | schedules | | | |
| trend | for predefined | | | | |
| (Agent | duration/rating = 3 | | | | |
| Quotient | Absenteeism for | | | | |
| Parameter) | more than 5 and less | | | | |
| | than 10 schedules for | | | | |
| | predefined | | | | |
| | duration/rating = 2 | | | | |
| | Absenteeism for | | | | |
| | more than 5 and less | | | | |
| | than 15 schedules for | | | | |
| | predefined | | | | |
| | duration/rating = 1 | | | | |
| | Absenteeism for | | | | |
| | more than 15 schedules | | | | |
| | for predefined | | | | |
| | duration/rating = 0 | | | | |
| Agent | 85% and | 85% | 5 | 5 | 25 |
| occupancy rate | above/rating = 5 | | | | |
| (Agent | 70% and | | | | |
| Quotient | above/rating =4 | | | | |
| Parameter) | 60% and | | | | |
| | above/rating =3 | | | | |
| | 50% and | | | | |
| | above/rating = 2 | | | | |
| | 30% and | | | | |
| | above/rating = 1 | | | | |
| | Below 30%/rating = | | | | |
| | 0 | | | | |
| Average | Exceptional/rating = | Excellent | 4 | 5 | 20 |
| manager | 5 | | | | |
| feedback in the | Excellent/rating = | | | | |
| past (Agent | 4 | | | | |
| Quotient | Successful/rating = | | | | |
| Parameter) | 3 | | | | |
| | Inconsistent/rating = | | | | |
| | 2 | | | | |
| | Requires | | | | |
| | improvement/rating = 1 | | | | |
| Agent current | Exceptional/rating = | Average | 2 | 5 | 10 |
| proficiency | 5 | | | | |
| (Agent Skill | Excellent/rating = | | | | |
| Quotient | 4 | | | | |
| Parameter) | Average/rating = 2 | | | | |
| | Below | | | | |
| | average/rating = 0 | | | | |
| Overall | Very | Neutral | 1 | 5 | 5 |
| customer | satisfied/rating = 3 | | | | |
| feedback | Satisfied/rating = 2 | | | | |
| (Agent Skill | Neutral/rating = 1 | | | | |
| Quotient | Unsatisfied/rating = | | | | |
| Parameter) | 0 | | | | |
| Escalation | If escalation more | No | 1 | 5 | 5 |
| count | than 1, then rating | escalations | | | |
| (Agent Skill | should be zero, else | | | | |
| Quotient | rating is 1 for no | | | | |
| Parameter) | escalations | | | | |
| Schedule | Greater than | 75% | 2 | 5 | 10 |
| adherence | 80%/rating = 3 | | | | |
| (Agent Skill | Greater than | | | | |
| Quotient | 70%/rating =2 | | | | |
| Parameter) | Greater than | | | | |
| | 50%/rating = 1 | | | | |
| | 50% or less/rating = | | | | |
| | 0 | | | | |
| Count of time- | Less than 5/rating = | 1 | 5 | 5 | 5 |
| offs availed | 10 | | | | |
| (Agent Skill | Greater than 5 and | | | | |
| Quotient | less than 10/rating = 5 | | | | |
| Parameter) | More than | | | | |
| | 10/rating = 0 | | | | |
| Count of agent | 5 skills/rating = 5 | 2 | 2 | 5 | 10 |
| skills that agent | 4 skills/rating = 4 | | | | |
| performed for | 3 skills/rating = 3 | | | | |
| specific interval | 2 skills/rating = 2 | | | | |
| (Agent Skill | 1 skill/rating = 1 | | | | |
| Quotient | No skill/rating = 0 | | | | |
| Parameter) | | | | | |

Agent Performance Quotient = ΣAgent Quotient + Agent Skill Quotient = 125

TABLE 2
AGENT BEHAVIOR QUOTIENT

| | Rating | | | | |
|---|---|---|---|---|---|
| | Determination | | | | Score |
| | Based on | Parameter | Rating | Weight | (rating × |
| Parameter | Parameter Value | Value | (0-5) | (1-5) | weight) |
| Acknowledge | Score ≤ | 0.7 | 4 | 4 | 16 |
| Loyalty | 0.20/rating = 1 | | | | |
| | Score >0.20 | | | | |
| | and ≤0.40/rating = | | | | |
| | 2 | | | | |
| | Score >0.40 | | | | |
| | and <0.60/rating = | | | | |
| | 3 | | | | |
| | Score >0.60 | | | | |
| | and ≤0.80/rating = | | | | |
| | 4 | | | | |
| | Score > | | | | |
| | 0.80/rating = 5 | | | | |
| Active | Score ≤ | 0.65 | 4 | 4 | 16 |
| | 0.20/rating = 1 | | | | |
| | Score >0.20 | | | | |
| | and ≤0.40/rating = | | | | |
| | 2 | | | | |
| Listening | Score >0.40 | | | | |
| | and ≤0.60/rating = | | | | |
| | 3 | | | | |
| | Score >0.60 | | | | |
| | and ≤0.80/rating = | | | | |
| | 4 | | | | |
| | Score > | | | | |
| | 0.80/rating = 5 | | | | |
| Be Empathetic | Score ≤ | 0.45 | 3 | 3 | 9 |
| | 0.20/rating = 1 | | | | |
| | Score >0.20 | | | | |
| | and ≤0.40/rating = | | | | |
| | 2 | | | | |
| | Score >0.40 | | | | |
| | and ≤0.60/rating = | | | | |
| | 3 | | | | |
| | Score >0.60 | | | | |
| | and ≤0.80/rating = | | | | |
| | 4 | | | | |
| | Score > | | | | |
| | 0.80/rating = 5 | | | | |
| Build Rapport | Score ≤ | 0.3 | 2 | 2 | 4 |
| | 0.20/rating = 1 | | | | |
| | Score >0.20 | | | | |
| | and ≤0.40/rating = | | | | |
| | 2 | | | | |
| | Score >0.40 | | | | |
| | and ≤0.60/rating = | | | | |
| | 3 | | | | |
| | Score >0.60 | | | | |
| | and ≤0.80/rating = | | | | |
| | 4 | | | | |
| | Score > | | | | |
| | 0.80/rating = 5 | | | | |
| Demonstrate | Score ≤ | 0.85 | 5 | 5 | 25 |
| Ownership | 0.20/rating = 1 | | | | |
| | Score >2.0 | | | | |
| | and ≤0.40/rating = | | | | |
| | 2 | | | | |
| | Score >0.4 | | | | |
| | and ≤0.6/rating = | | | | |
| | 3 | | | | |
| | Score >0.60 | | | | |
| | and ≤0.80/rating = | | | | |
| | 4 | | | | |
| | Score > | | | | |
| | 0.80/rating = 5 | | | | |
| Effective | Score ≤ | 0.82 | 5 | 5 | 25 |
| Questioning | 0.20/rating = 1 | | | | |
| | Score >0.20 | | | | |
| | and ≤0.40/rating = | | | | |
| | 2 | | | | |
| | Score >0.40 | | | | |
| | and ≤0.60/rating = | | | | |
| | 3 | | | | |
| | Score >0.60 | | | | |
| | and ≤0.80/rating = | | | | |
| | 4 | | | | |
| | Score > | | | | |
| | 0.80/rating = 5 | | | | |
| Interruption | Score ≤ | 0.14 | 1 | 5 | 5 |
| | 0.20/rating = 1 | | | | |
| | Score >0.20 | | | | |
| | and ≤0.40/rating = | | | | |
| | 2 | | | | |
| | Score >0.40 | | | | |
| | and ≤0.60/rating = | | | | |
| | 3 | | | | |
| | Score >0.60 | | | | |
| | and ≤0.80/rating = | | | | |
| | 4 | | | | |
| | Score > | | | | |
| | 0.80/rating = 5 | | | | |
| Promote Self- | Score ≤ | 0.55 | 3 | 3 | 9 |
| service | 0.20/rating = 1 | | | | |
| | Score >0.20 | | | | |
| | and ≤0.40/rating = | | | | |
| | 2 | | | | |
| | Score >0.40 | | | | |
| | and ≤0.60/rating = | | | | |
| | 3 | | | | |
| | Score >0.60 | | | | |
| | and ≤0.80/rating = | | | | |
| | 4 | | | | |
| | Score > | | | | |
| | 0.80/rating = 5 | | | | |
| Set | Score ≤ | 0.7 | 4 | 3 | 12 |
| | 0.20/rating = 1 | | | | |
| | Score >0.20 | | | | |
| | and ≤0.40/rating = | | | | |
| | 2 | | | | |
| Expectations | Score >0.40 | | | | |
| | and ≤0.60/rating = | | | | |
| | 3 | | | | |
| | Score >0.60 | | | | |
| | and ≤0.80/rating = | | | | |
| | 4 | | | | |
| | Score > | | | | |
| | 0.80/rating = 5 | | | | |
| Speech | Score ≤ | 0.45 | 3 | 3 | 9 |
| Velocity | 0.20/rating = 1 | | | | |
| | Score >0.20 | | | | |
| | and ≤0.40/rating = | | | | |
| | 2 | | | | |
| | Score >0.40 | | | | |
| | and ≤0.60/rating = | | | | |
| | 3 | | | | |
| | Score >0.60 | | | | |
| | and ≤0.80/rating = | | | | |
| | 4 | | | | |
| | Score > | | | | |
| | 0.80/rating = 5 | | | | |
| Inappropriate | Score ≤ | 0.75 | 4 | 3 | 12 |
| Action | 0.20/rating = 1 | | | | |
| | Score >0.20 | | | | |
| | and ≤0.40/rating = | | | | |
| | 2 | | | | |
| | Score >0.40 | | | | |
| | and ≤0.60/rating = | | | | |
| | 3 | | | | |
| | Score >0.60 | | | | |
| | and ≤0.80/rating = | | | | |
| | 4 | | | | |
| | Score > | | | | |
| | 0.80/rating = 5 | | | | |

Agent Behavior Quotient =142

Table 3 provides simulated calculations of proficiency scores and proficiency deviations.

TABLE 3
PROFICIENCY SCORES AND PROFICIENCY DEVIATIONS

| Agent | | Agent Current | Agent Previous | | |
|---|---|---|---|---|---|
| Performance | Agent Behavior | Proficiency | Proficiency | Proficiency | |
| Quotient | Quotient | Score | Score | Deviation | System Action |
| 275 | 27 | 200.6 | 100 | 100.6 | Goes to |
| | | | | | Supervisor |
| 200 | 20 | 146 | 100 | 46 | Auto Approved |
| 190 | 25 | 140.5 | 100 | 40.5 | Auto Approved |
| 143 | 10 | 103.1 | 100 | 3.1 | Auto Approved |
| 136 | 13 | 99.1 | 100 | 0.9 | Auto Approved |
| 216 | 15 | 155.7 | 100 | 55.7 | Goes to |
| | | | | | Supervisor |
| 265 | 27 | 193.6 | 100 | 93.6 | Goes to |
| | | | | | Supervisor |
| 50 | 23 | 41.9 | 100 | −58.1 | Goes to |
| | | | | | Supervisor |
| 90 | 26 | 70.8 | 100 | −29.2 | Auto Approved |
| 144 | 11 | 104.1 | 100 | 4.1 | Auto Approved |
| 178 | 13 | 128.5 | 100 | 28.5678 | Auto Approved |
| 195 | 17 | 141.6 | 100 | 41.6 | Auto Approved |
| 220 | 15 | 158.5 | 100 | 58.5 | Goes to |
| | | | | | Supervisor |
| 152 | 27 | 114.5 | 100 | 14.5 | Auto Approved |
| 160 | 23 | 118.9 | 100 | 18.9 | Auto Approved |
| 230 | 20 | 167 | 100 | 67 | Goes to |
| | | | | | Supervisor |
| 240 | 25 | 90 | 175.5 | 75.5 | Goes to |
| | | | | | Supervisor |

In several embodiments, the agent proficiency score is associated with a proficiency level, as shown in Table 4 below.

TABLE 4
PROFICIENCY LEVELS

| Proficiency Score Range | Proficiency Level |
|---|---|
| 0-100 | 4 |
| 101-200 | 3 |
| 201-300 | 2 |
| 301-400 | 1 |

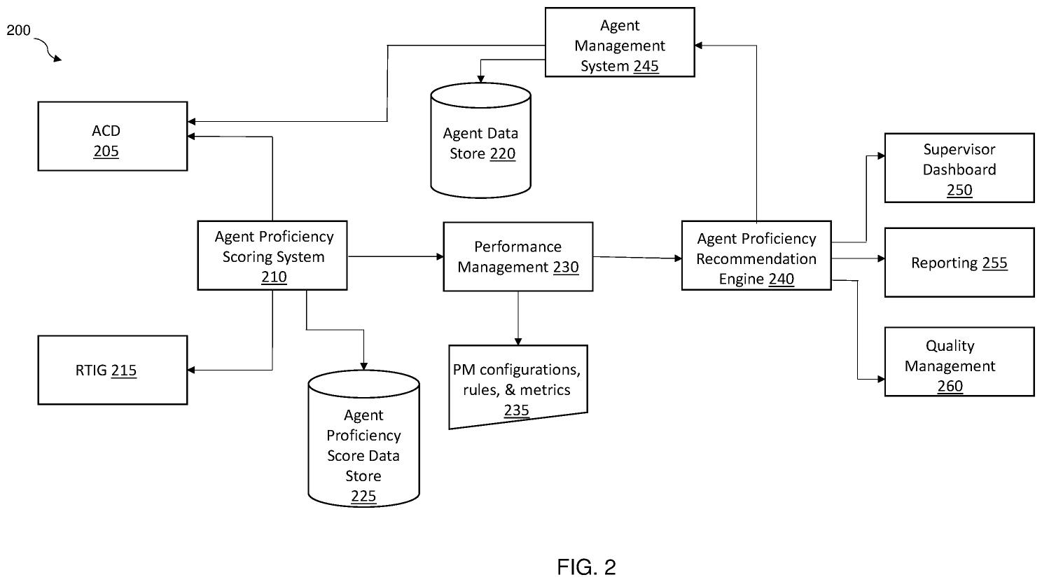

Referring now to FIG. 2, shown is an exemplary system 200 that integrates the agent proficiency scoring system into performance management. In one embodiment, ACD 205 is a telephony system that routes incoming calls to the most appropriate agent or department. Real-time interaction guidance (RTIG) 215 is a system that provides real-time support and guidance to agents during customer interactions. Agent proficiency scoring system 210 calculates the agent proficiency score. The agent proficiency score data store 225 stores and manages the proficiency scores of agents for performance analysis. The agent data store 220 is a centralized database that stores comprehensive information about agents, including their performance data. Performance management system 230 is responsible for monitoring, measuring, and improving agent performance to optimize productivity and customer service. Performance management configurations, rules, and metrics 235 is the setup and definition of rules and metrics for measuring and managing agent performance in the performance management system 230. Agent management system 245 is a platform that handles various aspects of agent-related tasks, such as scheduling, training, and performance evaluation. Agent proficiency recommendation engine 240 is an intelligent system that suggests agent proficiency and improvement strategies based on an agent's proficiency scores. Supervisor dashboard 250 is a dashboard for a person responsible for overseeing and managing a team of agents to ensure smooth operations and achieve performance goals. Reporting 255 is the process of generating and presenting data and insights on various aspects of contact center operations for analysis and decision-making. Quality management 260 is the process that ensures service quality and adherence to standards by monitoring and evaluating customer interactions.

Agent proficiency scoring system 210 provides agent proficiency scores to performance management system 230. Performance management system 230 subsequently provides agent performance metrics to agent proficiency recommendation engine 240, which sets agent proficiency levels and sends the proficiency levels to agent management system 245. Agent management system 245 sends the agent proficiency levels and scores to ACD 205, which then routes calls to the most proficient agent.

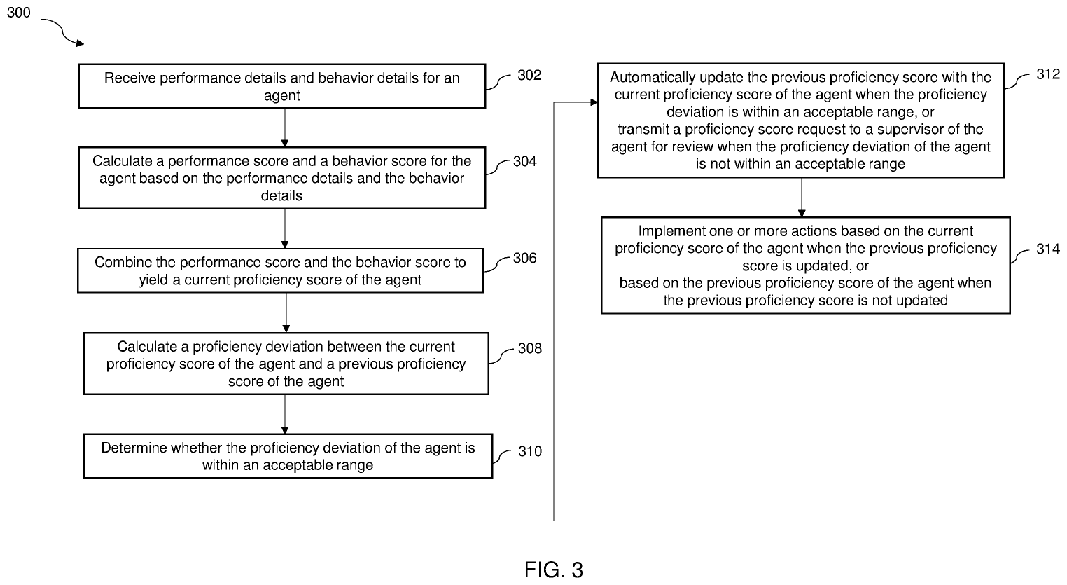

Referring now to FIG. 3, a method 300 according to embodiments of the present disclosure is described. At step 302, agent performance module 105 and agent behavior module 110 receive performance details and behavior details for an agent. In one or more embodiments, the performance details include one or more of a duration in a company, a reward or recognition, an absence from work, an occupancy rate, an average manager feedback, a previous proficiency level, an overall customer feedback, an escalation count, adherence to schedule, number of time-offs taken in a certain interval of time, or a number of skills that the agent used in a specific interval (e.g., a number of customer interactions, a time period, etc.). In some embodiments, the behavior details comprise one or more of acknowledging loyalty, active listening, being empathetic, building rapport, demonstrating ownership, effective questioning, interruption, promoting self-service, setting expectations, speech velocity, or inappropriate action.

At step 304, agent performance module 105 calculates a performance score and agent behavior module 110 calculates a behavior score for the agent based on the performance details and the behavior details.

At step 306, agent proficiency scoring module 115 combines the performance score and the behavior score to yield a current proficiency score of the agent. In one more embodiments, a weight is assigned to the performance score, a weight is assigned to the behavior score, and the performance score and the behavior score are multiplied by their respective weights before combining the performance score and the behavior score.

At step 308, agent proficiency scoring module 115 calculates a proficiency deviation between the current proficiency score of the agent and a previous proficiency score of the agent.

At step 310, agent proficiency scoring module 115 determines whether the proficiency deviation of the agent is within an acceptable range.

At step 312, agent proficiency scoring module 115 automatically updates the previous proficiency score of the agent with the current proficiency score of the agent when the proficiency deviation of the agent is within an acceptable range, or transmits a proficiency score request to a supervisor of the agent for review when the proficiency deviation of the agent is not within an acceptable range.

In certain embodiments, agent proficiency scoring module 115 receives an approval of the proficiency score request from the supervisor of the agent and updates the previous proficiency score of the agent with the current proficiency score of the agent after receiving the approval. In other embodiments, agent proficiency module 115 receives a rejection of the proficiency score request from the supervisor of the agent, and receive comments explaining the rejection from the supervisor of the agent.

At step 314, one or more actions are implemented based on the current proficiency score of the agent when the previous proficiency score is updated, or based on the previous proficiency score of the agent when the previous proficiency score of the agent is not updated. For example, ACD 125, quality management 130, or supervisor dashboard 140 may receive recommendations from recommendation engine 120 and implement the recommendations.

In some embodiments, the one or more actions include identifying an available agent with the highest current proficiency score and routing an incoming interaction to the available agent with the highest current proficiency score, assigning coaching to the agent, or displaying a proficiency score on a supervisor dashboard.

In various embodiments, method 200 further includes setting a current proficiency level of the agent based on the current proficiency score.

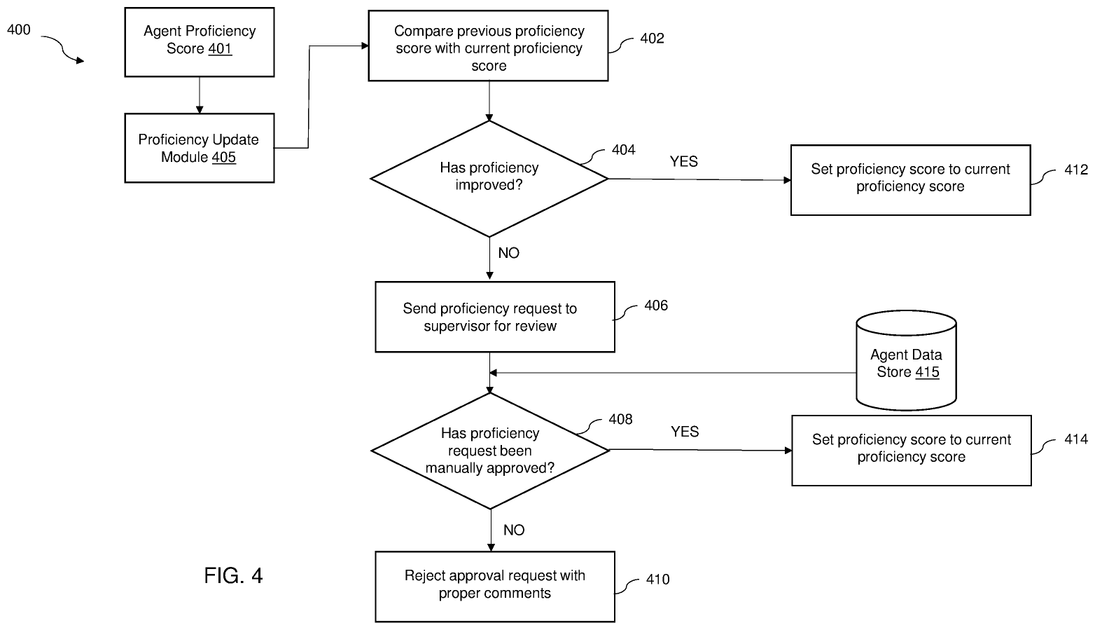

FIG. 4 is a flowchart of a method 400 to update agent proficiency scores. In various embodiments, the agent proficiency score 401 is transmitted to proficiency update module 405, a module that checks the proficiency score each time proficiency is calculated. At step 402, proficiency update module 405 compares the previous proficiency score with the current proficiency score. At step 404, proficiency update module 405 determines whether the proficiency score improved. If the proficiency score improved, proficiency update module 405 sets the proficiency score to the current proficiency score in step 412. If the proficiency score did not improve, proficiency update module 405 sends a proficiency request to a supervisor for review in step 406. If the proficiency is not automatically updated, then a request is sent to the supervisor for review, and the supervisor takes appropriate action based on agent data from agent data store 415. At step 408, proficiency update module 405 determines whether the proficiency request was manually approved by the supervisor. If the proficiency request was approved, then proficiency update module 405 sets the proficiency score to the current proficiency score in step 414. If the proficiency request is not manually approved by the supervisor, then proficiency update module 405 rejects the approval request with the supervisor's proper comments.

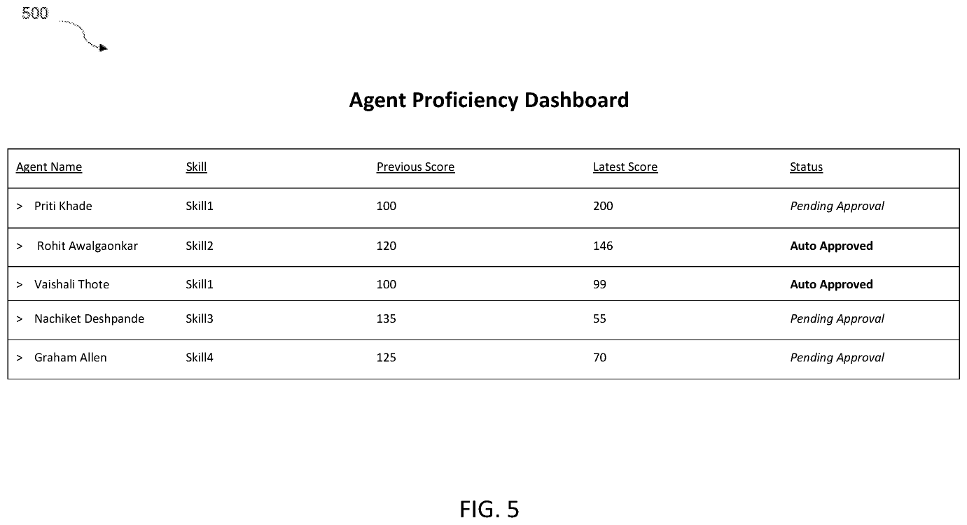

FIG. 5 provides a screenshot 500 of a supervisor dashboard 140. The screenshot shows that two agents' proficiency score changed automatically and the remaining three agents' proficiency score needs to be reviewed manually by a supervisor. In this embodiment, the proficiency scores that are automatically approved have a difference between the previous score and the latest score of less than 50. A difference of less than 50 between scores is a more “natural” difference compared to a difference of greater than 50. Accordingly, the latest proficiency scores that have a difference of less than 50 from the previous proficiency scores are automatically approved.

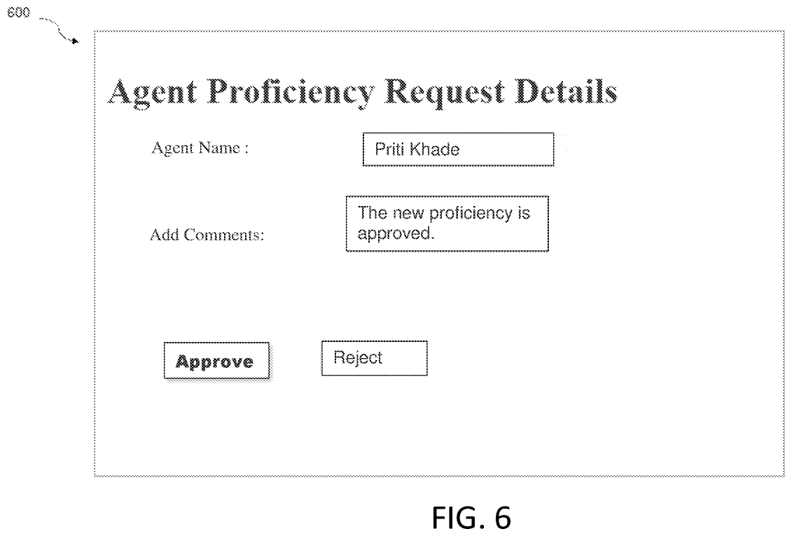

FIG. 6 is a screenshot 600 depicting how a supervisor can manually approve a new proficiency score with comments when a proficiency request is sent to the supervisor for review.

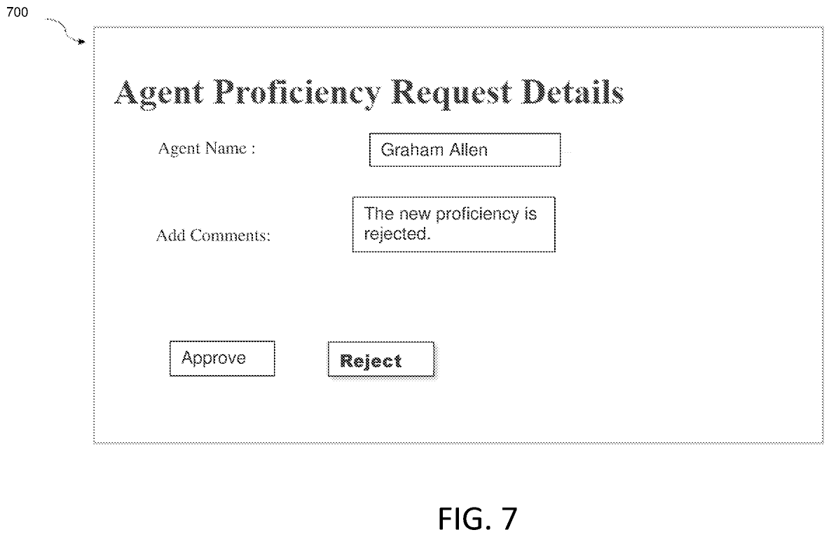

FIG. 7 is a screenshot 700 depicting how a supervisor can manually reject a new proficiency score with comments when a proficiency request is sent to the supervisor for review.

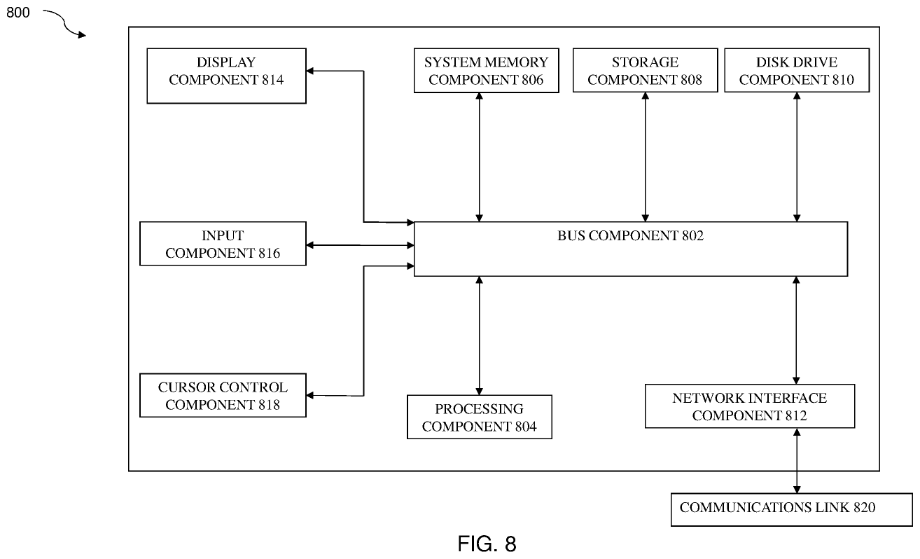

Referring now to FIG. 8, illustrated is a block diagram of a system 800 suitable for implementing embodiments of the present disclosure. System 800, such as part of a computer and/or a network server, includes a bus 802 or other communication mechanism for communicating information, which interconnects subsystems and components, including one or more of a processing component 804 (e.g., processor, micro-controller, digital signal processor (DSP), etc.), a system memory component 806 (e.g., RAM), a static storage component 808 (e.g., ROM), a network interface component 812, a display component 814 (or alternatively, an interface to an external display), an input component 816 (e.g., keypad or keyboard), and a cursor control component 818 (e.g., a mouse pad).

In accordance with embodiments of the present disclosure, system 800 performs specific operations by processor 804 executing one or more sequences of one or more instructions contained in system memory component 806. Such instructions may be read into system memory component 806 from another computer readable medium, such as static storage component 808. These may include instructions to receive performance details and behavior details for an agent; calculate a performance score and a behavior score for the agent based on the performance details and the behavior details; combine the performance score and the behavior score to yield a current proficiency score of the agent; calculate a proficiency deviation between the current proficiency score of the agent and a previous proficiency score of the agent; determine whether the proficiency deviation of the agent is within an acceptable range; automatically update the previous proficiency score of the agent with the current proficiency score of the agent when the proficiency deviation of the agent is within an acceptable range, or transmit a proficiency score request to a supervisor of the agent for review when the proficiency deviation of the agent is not within an acceptable range; and implement one or more actions based on the current proficiency score of the agent when the previous proficiency score is updated, or based on the previous proficiency score of the agent when the previous proficiency score of the agent is not updated. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 804 for execution. Such a medium may take many forms, including but not limited to, non-volatile media, volatile media, and transmission media. In various implementations, volatile media includes dynamic memory, such as system memory component 806, and transmission media includes coaxial cables, copper wire, and fiber optics, including wires that comprise bus 802. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 800. In various other embodiments, a plurality of systems 800 coupled by communication link 820 (e.g., LAN, WLAN, PTSN, or various other wired or wireless networks) may perform instruction sequences to practice the disclosure in coordination with one another. Computer system 800 may transmit and receive messages, data, information and instructions, including one or more programs (i.e., application code) through communication link 820 and communication interface 812. Received program code may be executed by processor 804 as received and/or stored in disk drive component 810 or some other non-volatile storage component for execution.

The Abstract at the end of this disclosure is provided to comply with 37 C.F.R. § 1.72 (b) to allow a quick determination of the nature of the technical disclosure. It is submitted with the understanding that it will not be used to interpret or limit the scope or meaning of the claims.

What is claimed is:

1. An agent proficiency scoring system comprising:
a processor and a computer readable medium operably coupled thereto, the computer readable medium comprising a plurality of instructions stored in association therewith that are accessible to, and executable by, the processor, to perform operations which comprise:
receiving performance details and behavior details for an agent;
calculating a performance score and a behavior score for the agent based on the performance details and the behavior details;
combining the performance score and the behavior score to yield a current proficiency score of the agent;
calculating a proficiency deviation between the current proficiency score of the agent and a previous proficiency score of the agent;
determining whether the proficiency deviation of the agent is within an acceptable range;
automatically updating the previous proficiency score of the agent with the current proficiency score of the agent when the proficiency deviation of the agent is within an acceptable range, or transmitting a proficiency score request to a supervisor of the agent for review when the proficiency deviation of the agent is not within an acceptable range; and
implementing one or more actions based on the current proficiency score of the agent when the previous proficiency score is updated, or based on the previous proficiency score of the agent when the previous proficiency score of the agent is not updated.

2. The agent proficiency scoring system of claim 1, wherein the performance details comprise one or more of a duration in a company, a reward or recognition, an absence from work, an occupancy rate, an average manager feedback, a previous proficiency level, an overall customer feedback, an escalation count, adherence to schedule, number of time-offs taken in a certain interval of time, or number of skills that the agent used in a specific interval.

3. The agent proficiency scoring system of claim 1, wherein the behavior details comprise one or more of acknowledging loyalty, active listening, being empathetic, building rapport, demonstrating ownership, effective questioning, interruption, promoting self-service, setting expectations, speech velocity, or inappropriate action.

4. The agent proficiency scoring system of claim 1, wherein the one or more actions comprises:
identifying an available agent with the highest current proficiency score and routing an incoming interaction to the available agent with the highest current proficiency score,
assigning coaching to the agent, or
displaying a proficiency score on a supervisor dashboard.

5. The agent proficiency scoring system of claim 1, wherein the operations further comprise:
assigning a weight to the performance score;
assigning a weight to the behavior score; and
multiplying the performance score and the behavior score by their respective weights before combining the performance score and the behavior score.

6. The agent proficiency scoring system of claim 1, wherein the operations further comprise setting a current proficiency level of the agent based on the current proficiency score.

7. The agent proficiency scoring system of claim 1, wherein the operations further comprise:
receiving an approval of the proficiency score request from the supervisor of the agent; and
updating the previous proficiency score of the agent with the current proficiency score of the agent after receiving the approval.

8. The agent proficiency scoring system of claim 1, wherein the operations further comprise:
receiving a rejection of the proficiency score request from the supervisor of the agent; and
receiving comments explaining the rejection from the supervisor of the agent.

9. A method of using agent proficiency to improve contact center performance, which comprises:
receiving performance details and behavior details for an agent;
calculating a performance score and a behavior score for the agent based on the performance details and the behavior details;
combining the performance score and the behavior score to yield a current proficiency score of the agent;
calculating a proficiency deviation between the current proficiency score of the agent and a previous proficiency score of the agent;
determining whether the proficiency deviation of the agent is within an acceptable range;
automatically updating the previous proficiency score of the agent with the current proficiency score of the agent when the proficiency deviation of the agent is within an acceptable range, or transmitting a proficiency score request to a supervisor of the agent for review when the proficiency deviation of the agent is not within an acceptable range; and
implementing one or more actions based on the current proficiency score of the agent when the previous proficiency score is updated, or based on the previous proficiency score of the agent when the previous proficiency score of the agent is not updated.

10. The method of claim 9, wherein the performance details comprise one or more of a duration in a company, a reward or recognition, an absence from work, an occupancy rate, an average manager feedback, a previous proficiency level, an overall customer feedback, an escalation count, adherence to schedule, number of time-offs taken in a certain interval of time, or number of skills that the agent used in a specific interval.

11. The method of claim 9, wherein the behavior details comprise one or more of acknowledging loyalty, active listening, being empathetic, building rapport, demonstrating ownership, effective questioning, interruption, promoting self-service, setting expectations, speech velocity, or inappropriate action.

12. The method of claim 9, wherein the one or more actions comprises:
identifying an available agent with the highest current proficiency score and routing an incoming interaction to the available agent with the highest current proficiency score,
assigning coaching to the agent, or
displaying a proficiency score on a supervisor dashboard.

13. The method of claim 9, which further comprises:
receiving an approval of the proficiency score request from the supervisor of the agent; and
updating the previous proficiency score of the agent with the current proficiency score of the agent after receiving the approval.

14. The method of claim 9, which further comprises:
receiving a rejection of the proficiency score request from the supervisor of the agent; and
receiving comments explaining the rejection from the supervisor of the agent.

15. A non-transitory computer-readable medium having stored thereon computer-readable instructions executable by a processor to perform operations which comprise:
receiving performance details and behavior details for an agent;
calculating a performance score and a behavior score for the agent based on the performance details and the behavior details;
combining the performance score and the behavior score to yield a current proficiency score of the agent;
calculating a proficiency deviation between the current proficiency score of the agent and a previous proficiency score of the agent;
determining whether the proficiency deviation of the agent is within an acceptable range;
automatically updating the previous proficiency score of the agent with the current proficiency score of the agent when the proficiency deviation of the agent is within an acceptable range, or transmitting a proficiency score request to a supervisor of the agent for review when the proficiency deviation of the agent is not within an acceptable range; and
implementing one or more actions based on the current proficiency score of the agent when the previous proficiency score is updated, or based on the previous proficiency score of the agent when the previous proficiency score of the agent is not updated.

16. The non-transitory computer-readable medium of claim 15, wherein the one or more actions comprises:
identifying an available agent with the highest current proficiency score and routing an incoming interaction to the available agent with the highest current proficiency score,
assigning coaching to the agent, or
displaying a proficiency score on a supervisor dashboard.

17. The non-transitory computer-readable medium of claim 15, wherein the performance details comprise one or more of a duration in a company, a reward or recognition, an absence from work, an occupancy rate, an average manager feedback, a previous proficiency level, an overall customer feedback, an escalation count, adherence to schedule, number of time-offs taken in a certain interval of time, or number of skills that the agent used in a specific interval.

18. The non-transitory computer-readable medium of claim 15, wherein the behavior details comprise one or more of acknowledging loyalty, active listening, being empathetic, building rapport, demonstrating ownership, effective questioning, interruption, promoting self-service, setting expectations, speech velocity, or inappropriate action.

19. The non-transitory computer-readable medium of claim 15, wherein the operations further comprise:
receiving an approval of the proficiency score request from the supervisor of the agent; and
updating the previous proficiency score of the agent with the current proficiency score of the agent after receiving the approval.

20. The non-transitory computer-readable medium of claim 15, wherein the operations further comprise:
receiving a rejection of the proficiency score request from the supervisor of the agent; and
receiving comments explaining the rejection from the supervisor of the agent.
